(19) United States
(12) Patent Application Publication
(10) Pub. No.: US 2019/0005239 A1
(43) Pub. Date: Jan. 3, 2019

(54) ELECTRONIC DEVICE FOR ANALYZING MALICIOUS CODE AND METHOD THEREFOR

(71) Applicant: SAMSUNG ELECTRONICS CO., LTD., Suwon-si, Gyeonggi-do (KR)

(72) Inventors: Hyeong-jin PARK, Suwon-si, Gyeonggi-do (KR); Kyeong-jae LEE, Seoul (KR); In-choon YEO, Suwon-si, Gyeonggi-do (KR)

(21) Appl. No.: 16/068,263

(22) PCT Filed: Nov. 1, 2016
(86) PCT No.: PCT/KR2016/012443

§ 371 Date: Jul. 5, 2018

(30) Foreign Application Priority Data
Jan. 19, 2016 (KR) 10-2016-0006257
Jun. 10, 2016 (KR) 10-2016-0072230

(51) Int. Cl. G06F 21/56

(52) U.S. Cl. CPC G06F 21/563; G06F 2221/033

(57) ABSTRACT

The present disclosure relates to a method for analyzing a malicious code by an electronic device, the method comprising the steps of: receiving an executable file; before the received executable file is installed, analyzing the executable file so as to collect suspected malicious code data from the executable file; normalizing the collected suspected malicious code data and analyzing the same on the basis of a probability model algorithm, so as to make a determination on the suspected malicious code data; and outputting the result of the determination.

### TECHNICAL FIELD

The present disclosure relates to an electronic device for detecting a malicious code, and more particularly, to a method and a device for providing a risk to a user by statistically measuring a degree of hacking exposure of an executable file through a probability model algorithm within a local region of a user terminal, and a computer readable medium having a program for executing the program recorded thereon.

### BACKGROUND ART

As the use of mobile devices (e.g., smartphones, tablet PCs, and the like) is increased, various application program interfaces (APIs) are being developed. Accordingly, the user may directly develop and publish an application, and may freely install and use the published other applications.

However, malicious applications that may collect information inside the user terminal and transmit it to the outside may be present in the published application. In addition, since recent malicious applications disguise as normal applications, a probability that personal information of the user is leaked without user's knowledge is increased.

Conventionally, in a method for detecting a malicious code of the application installed in the mobile device, there is a problem in that a program for detecting a malicious code is installed and the installed program should be periodically updated by downloading the latest malicious code and virus related search engine or database from a server when the mobile device is connected to communication such as Wifi or the like. In addition, according to the conventional technology, a risk of the malicious code was inferred by comparing existing malicious code present in the database with feature data (e.g., metadata, a name of a source file, signature, and the like) included in the application of the user. Therefore, the conventional technology has a problem that dependency on the database of the server is high and it is difficult to reflect the latest hacking trend.

### DISCLOSURE

### Technical Problem

An object of the present disclosure is to provide a method and a device for analyzing a source code by decompiling an executable file based on a terminal device rather than based on a server, and providing a result obtained by inferring a suspected malicious code file included in the executable file to a user.

According to an aspect of the present disclosure, a method for analyzing a malicious code of an electronic device includes receiving an executable file; collecting suspected malicious code data from the executable file by analyzing the executable file before installing the received executable file; determining the suspected malicious code data by analyzing the collected suspected malicious code data based on a probability model algorithm; and outputting a result of the determination.

The collecting of the suspected malicious code data may include restoring a machine code of the executable file into a source code level by decompiling the machine code, and the suspected malicious code data may be collected at the restored source code level.

In the restoring of the machine code, when the machine code of the executable file is encrypted, the machine code may be restored into the source code level by decompiling the machine code.

The collecting of the suspected malicious code data may include analyzing the suspected malicious code data at a native source level by collecting a symbol table and a character constant of the executable file.

The collecting of the suspected malicious code data may include analyzing the suspected malicious code data at a native source level by decompiling the executable file into an intermediate representation (IR) code level using a low level virtual machine (LLVM) compiler.

The collecting of the suspected malicious code data may include analyzing the suspected malicious code data based on metadata of the executable file and execution privilege information of the executable file within a mobile operating system.

The collecting of the suspected malicious code data may include analyzing the suspected malicious code data based on different information data inside the file through decoding, decompression, a check of a header file, and a comparison of byte values for each particular file so as to detect another executable file or a command hidden in another file format in the executable file.

The method may further include normalizing the collected data so as to allow the normalized data to be input to the probability model algorithm.

In the outputting of the result of the determination, when it is determined that the malicious code data is present as the result of the determination, at least one of type and probability information of the determination malicious code data may be output.

The probability model algorithm may be at least one of a deep learning engine, a support vector machine (SVM), and a neural network algorithm.

According to another aspect of the present disclosure, an electronic device for analyzing a malicious code includes a display; and a processor configured to receive an executable file, collect suspected malicious code data from the executable file by analyzing the executable file before installing the received executable file, determine the suspected malicious code data by analyzing the collected suspected malicious code data based on a probability model algorithm, and output a result of the determination.

The processor may restore a machine code of the executable file into a source code level by decompiling the machine code, and collect the suspected malicious code data at the restored source code level.

When the machine code of the executable file is encrypted, the processor may restore the machine code into the source code level by decompiling the machine code.

The processor may collect the suspected malicious code data by analyzing the suspected malicious code data at a native source level by collecting a symbol table and a character constant of the executable file.

The processor may collect the suspected malicious code data by analyzing a native source level by decompiling the executable file into an intermediate representation (IR) code level using a low level virtual machine (LLVM) compiler.

The processor may collect the suspected malicious code data by analyzing metadata of the executable file and execution privilege information of the executable file within a mobile operating system.

The processor may collect the suspected malicious code data by analyzing different information data inside the file through decoding, decompression, a check of a header file, and a comparison of byte values for each particular file so as to detect another executable file or a command hidden in another file format in the executable file.

The electronic device may further include a memory configured to store normalized data by normalizing the collected data so as to allow the normalized data to be input to the probability model algorithm.

When it is determined that the malicious code data is present as the result of the determination, the processor may output at least one of type and probability information of the determination malicious code data.

According to another aspect of the present disclosure, a computer readable recording medium having a program for performing a method for analyzing a malicious code of an electronic device stored thereon is provided, wherein the method includes: receiving an executable file; collecting suspected malicious code data from the executable file by analyzing the executable file before installing the received executable file; determining the suspected malicious code data by analyzing the collected suspected malicious code data based on a probability model algorithm; and outputting a result of the determination.

### Advantageous Effects

As described above, in the method for detecting the malicious code according to the exemplary embodiments of the present disclosure, since it is possible to provide the device and the method capable of more quickly and accurately whether or not the malicious code is infected in the source code by analyzing the source code of the executable file utilizing the de-compiler in the terminal device.

### DESCRIPTION OF DRAWINGS

FIG. 1 is a schematic block diagram illustrating a configuration of an electronic device according to an exemplary embodiment of the present disclosure;

FIG. 2 is a block diagram illustrating a configuration of a program for detecting a malicious code according to an exemplary embodiment of the present disclosure;

FIG. 3 is a diagram illustrating a configuration of a low level virtual machine (LLVM) compiler according to an exemplary embodiment of the present disclosure;

FIG. 4 is a diagram illustrating a method for showing a malicious code analysis result to a user according to an exemplary embodiment of the present disclosure;

FIG. 5 is a flowchart illustrating a method for detecting suspected malicious code data according to an exemplary embodiment of the present disclosure;

FIG. 6 is a flowchart illustrating a method for collecting suspected malicious code data according to an exemplary embodiment of the present disclosure;

FIG. 7 is a flowchart illustrating a method for statistically measuring the collected suspected malicious code data according to an exemplary embodiment of the present disclosure;

FIG. 8 is a diagram illustrating a situation in which the suspected malicious code data is detected in a first electronic device and the detected result is transmitted to a second electronic device according to an exemplary embodiment of the present disclosure;

FIGS. 9 and 10 are diagrams illustrating a situation in which the suspected malicious code data is detected when a program for detecting the malicious code is not present in the electronic device according to an exemplary embodiment of the present disclosure;

and

FIG. 11 is a diagram illustrating another situation in which the electronic device detects the suspected malicious code data according to an exemplary embodiment of the present disclosure.

### BEST MODE

Terms used in the present specification will be briefly described and the present invention will be described in detail.

As the terms used in the present disclosure, general terms which are currently used as widely possible as are selected while considering functions in the present disclosure, but may be varied depending on an intention of those skilled in the art, a practice, an emergence of new technologies, and the like. In addition, in a certain case, there are terms which are arbitrarily selected by an applicant, and in this case, a meaning thereof will be described in detail in a description part of the disclosure corresponding to the terms. Therefore, the terms used in the present disclosure should be defined based on the meanings of the terms and the contents throughout the present disclosure, not simple names of the terms.

Exemplary embodiments of the present disclosure may be diversely modified and the present disclosure may have diverse exemplary embodiments. Accordingly, specific exemplary embodiments are illustrated in the drawings and are described in detail in the detailed description. However, it is to be understood that the present disclosure is not limited to a specific exemplary embodiment, but includes all modifications, equivalents, and substitutions without departing from the scope and spirit of the present disclosure. In describing the exemplary embodiments, when it is determined that a specific description of known technologies would obscure the gist of the present disclosure, a detailed description thereof will be omitted.

Terms such as first, second, etc. can be used to describe various components, but the components should not be limited to the terms. The terms are only used to distinguish one component from the others.

As used herein, the singular forms are intended to include plural forms as well, unless the context clearly indicates otherwise. In the present application, the terms “include” or “consist of” intend to designate the presence of features, numbers, steps, operations, components, elements, or a combination thereof that are written in the specification, but do not exclude the presence or possibility of addition of one or more other features, numbers, steps, operations, components, elements, or a combination thereof.

In the present disclosure, a “module” or a “unit” performs at least one function or operation, and may be implemented in hardware, software, or a combination of hardware and software. In addition, a plurality of “modules” or a plurality of “units” may be integrated into at least one module and may be implemented in at least one processor (not shown), except for a ‘module’ or a ‘unit’ in which they need to be implemented in specific hardware.

The methods described in the present disclosure mean one or a plurality of computer programs having specific purpose stored in a storage device. The program software performs functions implemented to it by directly providing instructions to computer hardware or providing an input to other software. In addition, the executable file refers to not only a file including only data, but also a computer file that performs an instructed operation according to an encrypted command. Files including commands for an interpreter, a CPU, or a virtual machine may be regard as the executable files. In addition, the executable file is a script or a byte code. The executable files are called binary files, which are terms that contrast with a native code of the program.

In general, the executable files interact with each other in an operating system, and some operating systems distinguish the executable files with file extensions, or recognize the files according to metadata. Most operating systems may protect arbitrary bit sequences in inadvertently performing the file as a command by verifying whether the corresponding file is in a correct executable file format. Recent operating systems have a control for resources of a computer, which requires each program to call the system to access the authorized resources. Since each operating system series has its own call structure, the executable files are generally limited to a specific operation system.

The “executable file” used in the present disclosure includes a computer file that performs an instructed operation according to an encoded command, as an executable file used in a computer science. In addition, the executable file in the present disclosure includes an application intended to be installed in the electronic device. In addition, the “executable file” may also include a contents file such as games, pictures, music, and the like.

A term “user” used in the present disclosure may refer to a person using the electronic device or a device (an artificial intelligence electronic device) using the electronic device.

Hereinafter, exemplary embodiments of the present disclosure will be described in detail with reference to the accompanying drawings so that those skilled in the art may easily practice the present disclosure. However, the present disclosure may be implemented in various different forms and is not limited to the exemplary embodiments provided in the present description. In the accompanying drawings, portions unrelated to the description will be omitted in order to obviously describe the present disclosure, and similar reference numerals will be used to describe similar portions throughout the present specification.

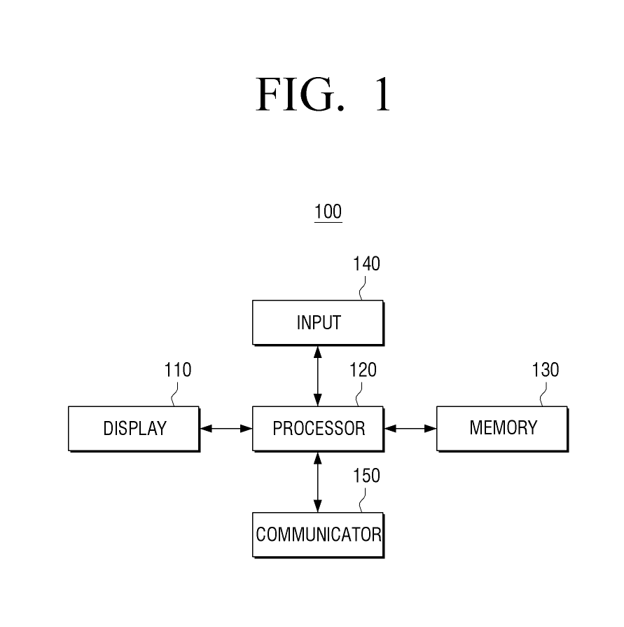

FIG. 1 is a schematic block diagram illustrating a configuration of an electronic device according to an exemplary embodiment of the present disclosure.

Referring to FIG. 1, an electronic device 100 may include a display 110, a processor 120, a memory 130, an input 140, and a communicator 150.

The display 110 may display an executable file received by the electronic device 100 on a touch screen, according to an exemplary embodiment of the present disclosure. The display 110 may display various input commands through a user interface (UI) so that a command for an installation of the executable file displayed on the display 110 is input through the input 140.

The display 110 may be a liquid-crystal display (LCD), an active-matrix organic light-emitting diode (AM-OLED), or the like. The display 110 may be implemented to be flexible, transparent, or wearable.

The processor 120 may receive the commands from the display 110, the memory 130, the input 140, and the communicator 150 to decrypt the received command and to execute an operation or a data processing according to the decrypted commands.

The processor 120 may receive the executable file and collect suspected malicious code data from the executable file by analyzing the executable file before the received executable file is installed, according to an exemplary embodiment of the present disclosure. In this case, the analysis of the executable file may decompile a machine code of the executable file through a static analysis to restore it to a source code level, and may collect the suspected malicious code data from the restored source code level.

In addition, the processor 120 may determine the suspected malicious code data by analyzing the suspected malicious code data stored in the memory 130 based on a probability model algorithm. In this case, the processor 120 may deduce the suspected malicious code data based on an artificial intelligence probability model algorithm such as a deep learning algorithm.

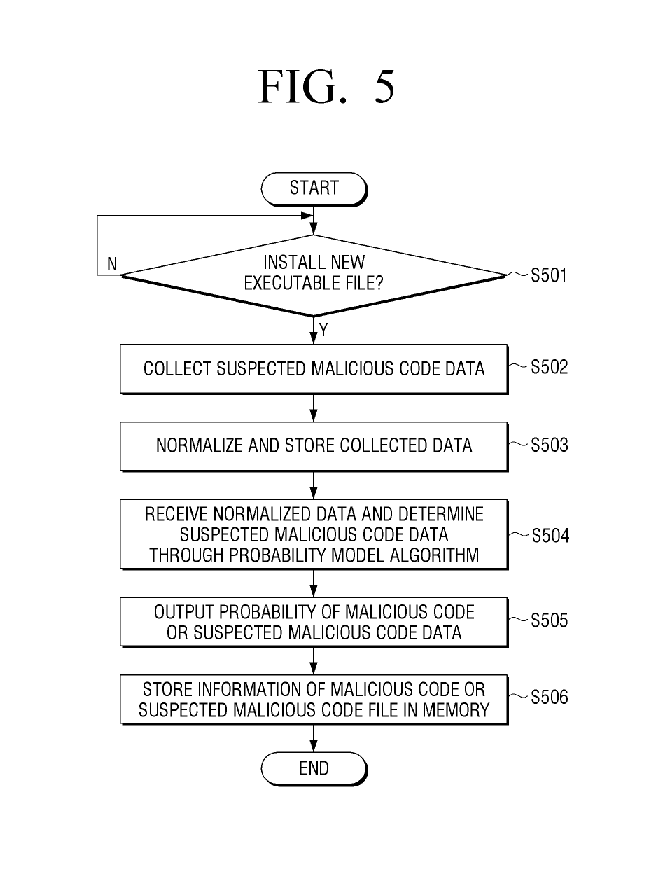

In addition, as a result of the determination, if it is determined that the malicious code data is present, the processor 120 may control the display 110 to output at least one of a type and probability information of the determined malicious code data. A detailed description of the processor 120 according to an exemplary embodiment of the present disclosure will be described below with reference to FIGS. 5 to 7.

The memory 130 may store a command or data received from the processor 120 or other components (e.g., the display 110, the input 140, the communicator 150, and the like), or generated by the processor 120 or other components. The memory 130 may include programming modules such as a kernel (not shown), middleware (not shown), an application programming interface (API), an application (not shown), an executable file (not shown), or the like. The respective programming modules described above may be configured in software, firmware, hardware, or a combination of two or more thereof.

The memory 130 may store data for analyzing a malicious code of the executable file according to an exemplary embodiment of the present disclosure. The data for analyzing the malicious code may be malicious data including the malicious code and clean data that does not include the malicious code. The memory 130 may store data obtained by normalizing and deducing the data collected by the processor 120 through a probability model algorithm such as a deep learning engine, a support vector machine (SVM), a neural network engine, or the like.

The memory 130 may include an internal memory (not shown) or an external memory (not shown). The internal memory (not shown) may include at least one of a volatile memory or a non-volatile memory. The volatile memory may be, for example, a dynamic RAM (DRAM), a static RAM (SRAM), a synchronous dynamic RAM (SDRAM), or the like. The non-volatile memory may be, for example, one time programmable ROM (OTPROM), a programmable ROM (PROM), an erasable and programmable ROM (EPROM), an electrically erasable and programmable ROM (EEPROM), a mask ROM, a flash ROM, a NAN flash memory, a NOR flash memory, or the like. In addition, the internal memory (not shown) may be a solid state drive (SSD).

The external memory (not shown) may include a flash drive, a compact flash (CF), a secure digital (SD), a micro secure digital (Micro-SD), a mini secure digital (Mini-SD), an extreme digital (xD), a memory stick, or the like. The external memory (not shown) may be functionally connected to the electronic device 100 through various interfaces. In addition, the electronic device 100 may further include a storage device such as a hard drive.

The input 140 may transfer the command or the data which is input from the user through an input and output device (e.g., a sensor, a keyboard, or a touch screen) to the processor 120, the memory 130, the communicator 150, or the like. The input 140 may provide data about a touch of the user which is input through the touch screen to the processor 120.

The input 140 may generate input data for controlling an operation of the electronic device 100 by the user according to an exemplary embodiment of the present disclosure. For example, the electronic device 100 may select the executable file through the input 140, and may be input with a command about whether to install the selected executable file or to cancel the installation of the selected executable file through the input 140.

The communicator 150 may perform communication between the electronic device 100 and external devices (e.g., a server, other electronic devices, and the like). The communicator 150 may be connected to a network (not shown) through wireless communication or wired communication to communicate with the external device (not shown).

The electronic device according to the present disclosure may be a device including a communication function. For example, the electronic device 100 may include at least one of a smartphone, a tablet PC, a mobile telephone, a video phone, an e-book reader, a netbook computer, a PDA, a portable multimedia player (PMP), an MP3 player, or a wearable device.

The wireless communication may include at least one of wireless fidelity (Wifi), Bluetooth (BT), near field communication (NFC), global positioning system (GPs), or cellular communication (e.g., LTE, LTE-A, CDMA, WCDMA, UMTS, Wibro, GSM, or the like). The wired communication may include at least one of a universal serial bus (USB), a high definition multimedia interface (HDMI), recommended standard 232 (RS-232), or a plain old telephone service (POTS).

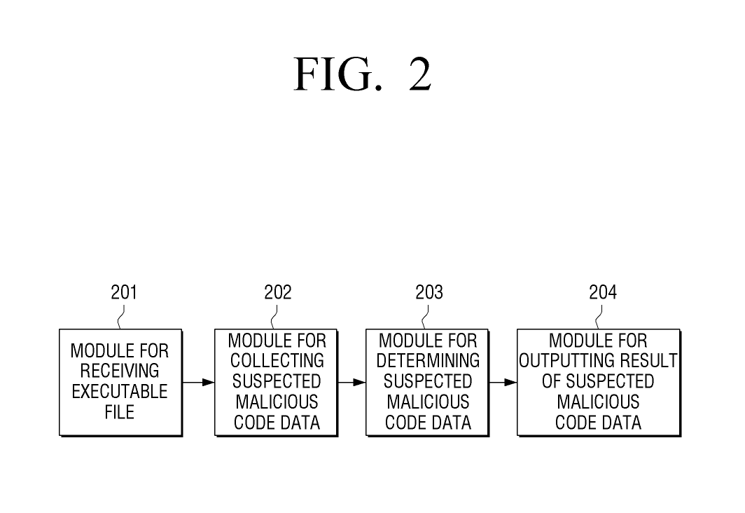

FIG. 2 is a block diagram illustrating a configuration of a program for detecting a malicious code according to an exemplary embodiment of the present disclosure.

Referring to FIG. 2, the program according to an exemplary embodiment of the present disclosure may include a module 201 for receiving an executable file, a module 202 for collecting suspected malicious code data, a module 203 for determining suspected malicious code data, and a module 204 for outputting a result of suspected malicious code data. The electronic device 100 may include one or more program modules for performing one or more tasks. However, the modules described above are merely examples for describing the present disclosure, but are not limited thereto and may be implemented in various modifications. In addition, the modules described above may be stored in the memory 130 as a computer readable recording medium which may be controlled by the processor 120.

In the present disclosure, Android™, iOS™, and the like among mobile operating systems will be described as an example.

The module 201 for receiving an executable file may allow the electronic device 100 to receive the executable file from an external server or an external device. The electronic device 100 may be input with a command that selects whether to install the received executable file or not to install the received executable file from the user. When the electronic device 100 is input with the command to install the received executable file from the user, the electronic device 100 may perform the module 202 for collecting suspected malicious code data.

The module 202 for collecting suspected malicious code data may collect various information of the received executable file from the electronic device 100. According to an exemplary embodiment of the present disclosure, the module 202 for collecting suspected malicious code data may decompile a machine code of the executable file to restore it to a source code level. In this case, the module 202 for collecting suspected malicious code data may collect the suspected malicious code data included in the executable file by analyzing the restored source code.

In addition, even in a case in which the machine code of the executable file is encrypted, the module 202 for collecting suspected malicious code data may collect the suspected malicious code data included in the executable file by analyzing the source code restored by decompiling the machine code.

The module 202 for collecting suspected malicious code data may collect a symbol table and a character constant by decompiling the executable file and collect the suspected malicious code data included in the executable file by analyzing the data at a native source level.

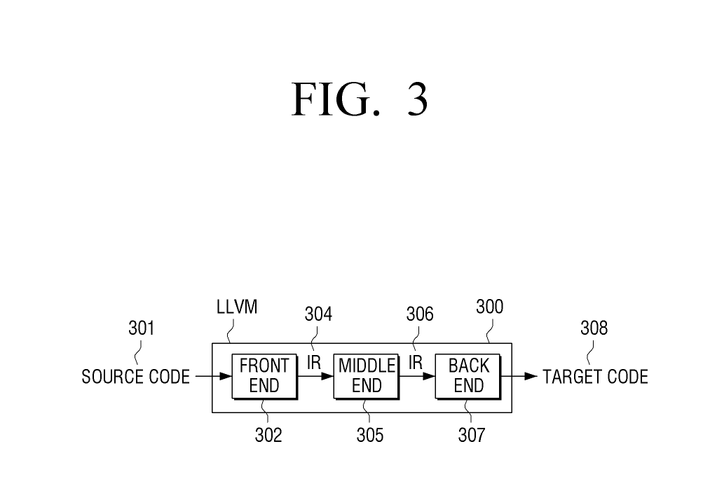

In addition, the module 202 for collecting suspected malicious code data may collect the suspected malicious code data included in the executable file by decompiling the executable file into an intermediate representation (IR) code level using a low level virtual machine (LLVM) complier and analyzing the suspected malicious code data at the native source level. The LLVM IR code according to an exemplary embodiment of the present disclosure will be described with reference to FIG. 3.

The module 202 for collecting suspected malicious code data may also collect the suspected malicious code data included in the executable file by analyzing the suspected malicious code data based on metadata of the executable file and execution authority information of the executable file within the mobile operating system. The metadata of the executable file may include a header file and/or other data fields of the executable file, and may collect the suspected malicious code data included in the executable file through an analysis of a heap size and a stack size.

In addition, the suspected malicious code data included in the executable file may be collected by analyzing the corresponding access authority information such as whether or not the executable file has access to a particular application on the mobile operating system (e.g., Android™, iOS™, Tizen™, or the like).

The module 202 for collecting suspected malicious code data may collect the suspected malicious code data included in the executable file by analyzing the suspected malicious code data based on different information data in the file through decoding, decompression, a check of a header file, a comparison of byte values, a magic number, and the like for each particular file so as to detect another executable file or a command hidden in another file format in the executable file.

In addition, the module 203 for determining suspected malicious code data may be input the data collected by the module 202 for collecting suspected malicious code data through the probability model algorithm. In addition, the module 203 for determining suspected malicious code data may deduce whether or not the executable file includes the suspected malicious code data based on the input data.

As an exemplary embodiment of the present disclosure, the exemplary embodiments of the present disclosure may be implemented using an artificial intelligence probability model algorithm such as a deep learning, a support vector machine (SVM), a neural network algorithm, or the like. The artificial intelligence probability model algorithm has a form in which machine learning is extended.

The module 204 for outputting a result of suspected malicious code data may display a malicious code probability of the executable file deduced from the module 203 for determining suspected malicious code data as probability data through the display of the electronic device 100. In this case, the displayed probability data may be displayed to the user through a graph, a chart, or an image, and may include detailed information (e.g., a developer, a distributor, a recommendation rate, and the like) on the executable file. Since various methods for displaying the deduced result on the electronic device 100 may be variously modified by those skilled in the art, a detailed description thereof will be omitted.

FIG. 3 is a diagram illustrating a configuration of a low level virtual machine (LLVM) compiler.

The present disclosure may be implemented using the LLVM compiler according to an exemplary embodiment. The LLVM, which is an open source solution, may optimize the code independently from the processor 120 of the electronic device 100, and may convert various source codes into various machine codes.

Referring to FIG. 3, the LLVM 300 compiler converts a received source code 301 into an intermediate representation 304 code through a front end 302. A middle end 305 optimizes the received IR 304 code to convert it into an IR 306 code and transmit it to a backend 307. The backend 307 generates a target code 308, which is a machine code, using a predefined target description file about the received optimized IR 306 code.

The IR 304 and 306 codes, which are programs representing an intermediate step between the source code and the target code, may more quickly and easily analyze the source code that it is difficult to translate.

According to an exemplary embodiment of the present disclosure, the module 202 for collecting suspected malicious code data described above in FIG. 2 may collect the suspected malicious code data included in the executable file by decompiling the executable file into an intermediate representation (IR) code level using a low level virtual machine (LLVM) complier and analyzing the suspected malicious code data at the native source level.

That is, if the target code 308, which is the machine code of the executable file, is decompiled using the LLVM compiler, the suspected malicious code data may be collected by analyzing it at the IR code level. As described above in FIG. 2, for example, the suspected malicious code data may be collected at a native or java native interface (JNI)™ level of Android™ at the IR code level.

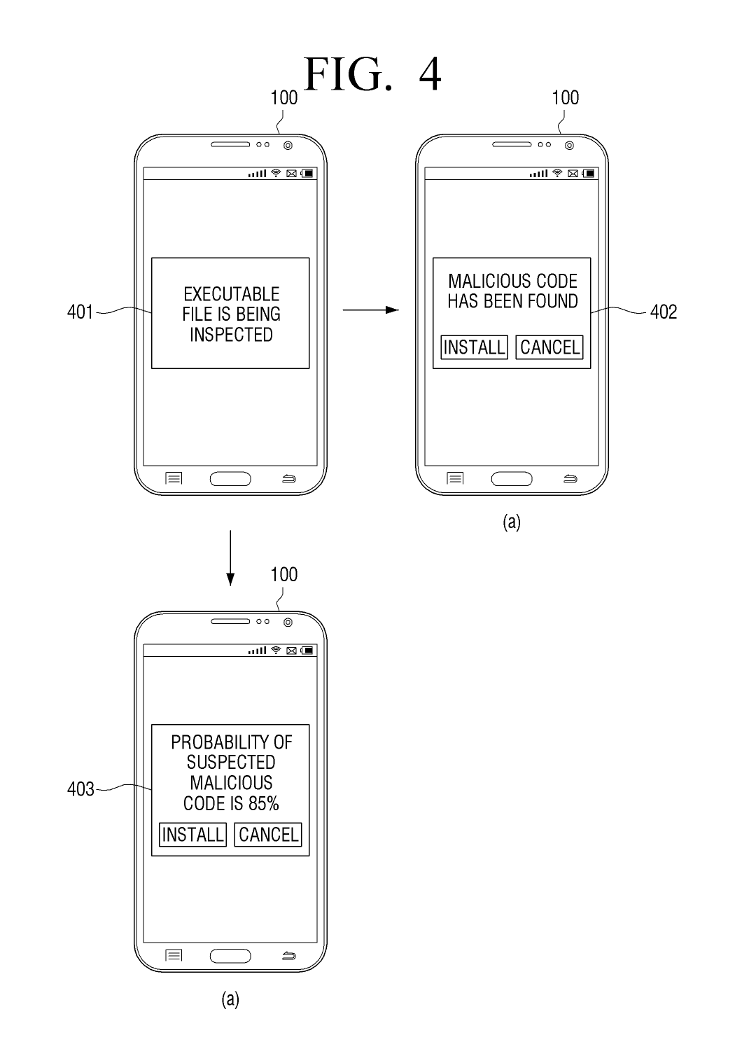

FIG. 4 is a diagram illustrating a method for showing a malicious code analysis result to a user according to an exemplary embodiment of the present disclosure.

Referring to FIG. 4, the electronic device 100 may display that the executable file is being inspected 401 on the display. In this case, the electronic device 100 may quickly display a process of analyzing a source code by decompiling the machine code of the executable file and a source path such as an analysis of a header file, or the like on a screen. In this case, the electronic device 100 may store data for analyzing the analyzed malicious code in the memory.

When the malicious code data is found in the executable file, the electronic device 100 may display a warning message 402 that the malicious code is found to the user. In this case, the user may continue to install the executable file (installation in 402), or cancel the installation thereof (cancellation in 402). When the user input a command that cancels the installation of the executable file (cancellation in 402) to the electronic device 100, the screen of the electronic device 100 may be changed to an application download program API.

In addition, the electronic device 100 may display probability data 403 that the suspected malicious data in the executable file is the malicious code to the user. In this case, the electronic device 100 may provide a suspected malicious code probability based on statistics extracted through the probability model algorithm. The electronic device 100 may display a warning message of whether to install the executable file or whether to cancel the installation of the executable file based on a value of the suspected malicious code probability. The electronic device 100 may divide the suspected malicious code probability for each section and may display a message or a graphic user interface (GUI) suggesting that the installation of the executable file is limited according to a predetermined probability threshold.

For example, when the probability that the executable file is a suspected malicious code file is 70% or more, the electronic device 100 may also display together a red warning on a warning window, and may also display a warning message to cancel the installation of the executable file. When the probability that the executable file is the suspected malicious code file is 50% or more and is less than 70%, the electronic device 100 may also display together an orange warning on the warning window, and may also display the warning message to cancel the installation of the executable file.

When the probability that the executable file is the suspected malicious code file is 30% or more and is less than 50%, the electronic device 100 may also display together a green warning on the warning window, and may also display the warning message to cancel the installation of the executable file. When the probability that the executable file is the suspected malicious code file is less than 30%, the electronic device 100 may also display together a blue warning on the warning window, and may also display the warning message to install the executable file or to cancel the installation of the executable file. However, the GUI display and the probability section of the warning message of the electronic device 100 are merely examples for describing the present disclosure, and the electronic device 100 may be implemented to output suspected malicious code result data of the executable file through various GUIs.

The method for implementing the suspected malicious code result data through the user interface (UI) may be implemented in various methods so that detailed information, a description, and the like of the executable file are displayed based on the analyzed result.

FIG. 5 is a flowchart illustrating a method for detecting suspected malicious code data according to an exemplary embodiment of the present disclosure.

Referring to FIG. 5, the electronic device 100 may determine whether to install a received new executable file (S501). The electronic device 100 may receive the executable file from an external server or an external device. For example, the electronic device 100 may receive various executable files through an application store on Android™ and iOS™. In addition, as an example, the electronic device 100 may also receive the executable file through the API such as SMS from other terminal devices. In this case, the electronic device 100 may be input with a command that selects whether to install the received executable file or not to install the received executable file from the user.

When the electronic device 100 is input with the command to install the received executable file from the user, the electronic device 100 may perform a collection of suspected malicious code data (S502).

The electronic device 100 may collect various information included in the received executable file. According to an exemplary embodiment of the present disclosure, the electronic device 100 may analyze the executable file through a static analysis and collect the suspected malicious code data. The static analysis is a method for restoring a machine code of the executable file to a source code (a native code) by decompiling the machine code of the executable file, and analyzing the suspected malicious code data from the restored source code (native code).

For example, in an Android™ operating system, when an Android package (APK), which is a package file distributed to install an application in an Android™ platform is decompressed, Manifest, Dalvik executable (DEX), and native library files may be collected. The DEX file is a file in which a class file is converted into a byte code to fit the Dalvik virtual machine. According to an exemplary embodiment of the present disclosure, the electronic device 100 may perform the analysis of the source code by decompiling the Manifest, the DEX, and the native library of the Android™.

In addition, even in a case in which the machine code of the executable file is encrypted, the electronic device 100 may collect the suspected malicious code data included in the executable file by analyzing the source code restored by decompiling the machine code. For example, in a case in which the source code is applied with encryption and obfuscation (e.g., Proguard™ or the like) in the Android™ operating system, it is difficult to analyze the source code. However, if the encrypted executable file is decompiled, a classes.dex file may be obtained. The source code may be confirmed by converting MainActivity.class into a java file in the classes.dex file obtained by decompiling the encrypted executable file.

The electronic device 100 may collect a symbol table and a character constant by decompiling the executable file and collect the suspected malicious code data included in the executable file by analyzing the data at a native source level. When a binary file is obtained by compiling the source code, the source code has the symbol table and the character constant including functions, variables, and the like used for the executable file. Therefore, the symbol table and the character constant of the executable file may be collected by decompiling the compiled binary file to again restore it to the source code.

For example, when it is needed to use the C library upon coding with JAVA™ in the Android™ operating system (e.g., audio, image processing, and the like), a Java native interface (JNI) connecting JAVA™ and C library to each other is required. That is, the JNI allows to call an application program interface (API) created by C/C++ in Android™ from JAVA™. A Java source code is run in the Dalvik virtual machine within Android™, but a sensor, a kernel, or the like within the electronic device 100 using the Android™ operating system accesses C/C++ through the JNI. Therefore, the suspected malicious code data included in the JNI, which is the native source level of Android™ may be collected through the source code written by C/C++ by decompiling the executable file.

In addition, the electronic device 100 may collect the suspected malicious code data included in the executable file by decompiling the executable file into an intermediate representation (IR) code level using a low level virtual machine (LLVM) complier and analyzing the suspected malicious code data at the native source level.

That is, if the target code 308, which is the machine code of the executable file, is decompiled using the LLVM compiler, the electronic device 100 may collect the suspected malicious code data by analyzing it at the IR code level. For example, the electronic device 100 may collect the suspected malicious code data at a native or JNI level of Android™ at the IR code level.

The electronic device 100 may also collect the suspected malicious code data included in the executable file by analyzing the suspected malicious code data based on metadata of the executable file and execution authority information of the executable file within the mobile operating system. The metadata of the executable file may include a header file and/or other data fields of the executable file, and may collect the suspected malicious code data included in the executable file through an analysis of a heap size and a stack size.

In addition, the suspected malicious code data included in the executable file may be collected by analyzing the corresponding access authority information such as whether or not the executable file has access to a particular application on the mobile operating system (e.g., Android™, iOS™, Tizen™, or the like). For example, the authority information of the executable file in the respective operating systems is included in AndroidManifest.xml, which is the Manifest file, in the case of Android™, is included in an Info.plist file in the case of iOS™, and is included in a privilege_desc file in the case of Tizen™.

The electronic device 100 may collect the suspected malicious code data included in the executable file by analyzing the suspected malicious code data based on different information data in the file through decoding, decompression, a check of header file, a comparison of byte value, and the like for each particular file so as to detect another executable file or a command hidden in another file format in the executable file.

For example, the APK, which is the package file of Android™, may include a .so file, which is an executable linking format, which is an executable file format for Linux, compiled for the ARM. In this case, according to an exemplary embodiment of the present disclosure, the analysis of the source code for an ELF file may be performed using a decompiler tool through the static analysis. In particular, in the case of the ELF file, the suspected malicious code data may be analyzed and collected by confirming feature information in the ELF file through a magic number.

The magic number is a magic byte identifying data fields in a header of the file according to a format of the file. An ELF header has information on the executable file and the magic number of the ELF is .ELF(0x7F 0x45 0x4C 0x46). In this case, the magic number of the ELF includes data and information on whether the file is an object file, an executable file, an ELF version, a file compiled for any operating system and bit, and the like.

As another example, in a case in which an actual file format (e.g., a malicious .so file) on the magic number and extension (e.g., a picture file such as .png or .jpg) of the file are different from each other, the module 202 for collecting suspected malicious code data may collect the suspected malicious code data included in the executable file.

As another example, when the extension of the executable file is the picture file such as .png or .jpg, the executable file may include other executable files or commands by disguising as the format of the picture file. In this case, the module 202 for collecting suspected malicious code data may analyze the suspected malicious code data by decompressing a specific file when the specific file (e.g., the format of the picture file such as .jpg or .png) is compressed, and decoding each specific file when the specific file is encrypted. In addition, the module 202 for collecting suspected malicious code data may collect the suspected malicious code data included in the executable file by decompiling the decoded and decompressed executable file, comparing the header file of the executable file and the byte value to each other, and analyzing the suspected malicious code data in the file.

The electronic device 100 may determine the suspected malicious code data by receiving the data normalized through a pre-processing process at a probability model algorithm (S504). In this case, the electronic device 100 may deduce whether or not the executable file includes the suspected malicious code data based on the received data.

As an exemplary embodiment of the present disclosure, the exemplary embodiments of the present disclosure may be implemented using an artificial intelligence probability model algorithm such as a deep learning, a support vector machine (SVM), a neural network algorithm, or the like. The artificial intelligence probability model algorithm has a form in which machine learning is extended.

A general machine learning probability model algorithm normalizes the collected data through the pre-processing process and inputs it to the probability model algorithm.

As a pre-processing main process, a data cleaning process of filling a missing value may be performed. For example, the missing value may be filled using the Bayesian formula. In addition, by a data integration process, inconsistent data may be corrected and redundancy of redundant data may be solved. In this case, when expressions of feature data having the same meaning are different from each other, the expressions may be stored by one rule, and the redundancy of the data may be solved through a correction analysis. In addition to this, it is possible to implement the normalization of the data using the pre-processing process of the data through various methods.

That is, the machine learning algorithm collects and analyzes the data, performs the pre-processing for the analyzed data to extract features of the pre-processed data, selects an algorithm that is suitable for the purpose, and deduces a final result through iterative learning. Therefore, the machine learning may solve the problem by creating the algorithm so that experts may assume and extract the features of the corresponding data.

On the other hand, the deep learning used in the present disclosure is an algorithm that learns the data extraction itself by including the pre-processing process in the machine learning described above in a neural network architecture. Therefore, when the deep learning algorithm is used as the probability model algorithm, the pre-processing process used in the present disclosure may be omitted and it is possible to more quickly and accurately obtain the deduction result.

In addition, the general machine learning algorithm deduces the deduction result by calculating a linear combination of values associated with the respective features. On the other hand, the deep learning algorithm may implement a high level of abstractions through a combination of non-linear transformation methods. That is, the deep learning algorithm may automatically perform a task that abstracts key contents or functions in a large amount of data or complex data without the pre-processing process.

The electronic device 100 may output a probability that the executable file is the suspected malicious code data through the probability model algorithm (S505). The electronic device 100 may display probability data of the deduced probability that the executable file is the malicious code through the display as described above with reference to FIG. 4. Since various methods for displaying the deduced result on the electronic device 100 may be variously modified by those skilled in the art, a detailed description thereof will be omitted.

In addition, the electronic device 100 may store the output malicious code, the suspected malicious code data, and the file information in the memory (S506). In this case, the stored malicious code related data may be used as a big data based database when the probability model algorithm is implemented.

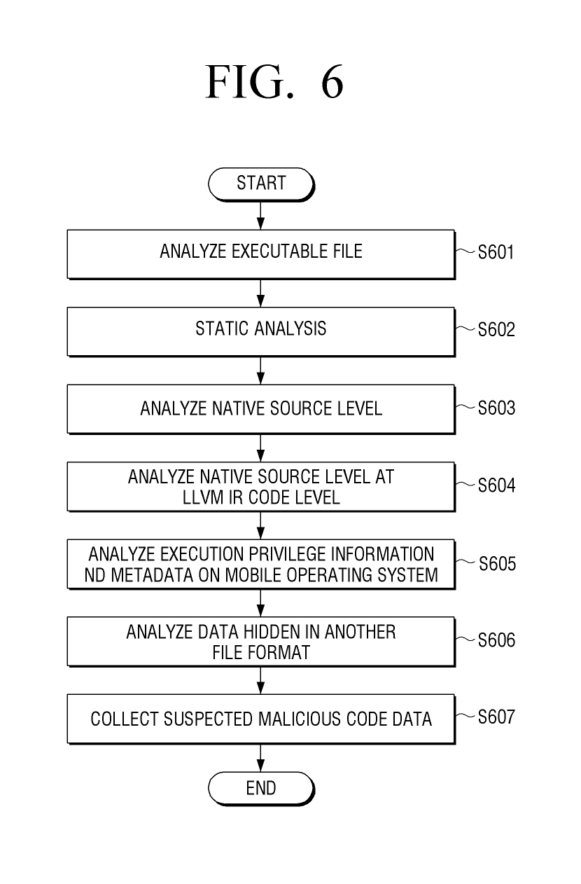

FIG. 6 is a flowchart illustrating a method for collecting suspected malicious code data according to an exemplary embodiment of the present disclosure.

Referring to FIG. 6, the electronic device 100 may analyze whether the executable file includes the malicious code, or has a risk that it is the malicious code (S601). According to an exemplary embodiment of the present disclosure, the electronic device 100 may analyze the executable file after receiving the executable file and before installing the executable file.

For example, the electronic device 100 may receive the executable file from an application market of Android™ or an APP store of iOS™. As another example, the electronic device 100 may receive the executable file from the external device or the external server through various APIs such as SMS API, album API, MUSIC API, game API, and the like.

As an example of the present disclosure, an Android™ operating system will be described. The executable file of Android™ has a package file structure called APK. In this case, the electronic device 100 may analyze an internal structure of APK by decompressing APK of Android™ compressed in a zip format.

According to an exemplary embodiment of the present disclosure, the electronic device 100 may collect the suspected malicious code data by performing a static analysis for the executable file (S602). The static analysis may extract and collect the suspected malicious code data included in the source code by analyzing the source code (native code) obtained by decompiling/disassembling an executable code of the executable file which is an object to be analyzed. The decompiled source code may include byte codes or assembly languages that may determine what action the executable file will perform.

In addition, the electronic device 100 may collect the suspected malicious code data by analyzing native instructions, byte codes, function names, data flow, and the like of the restored source code.

In addition, the electronic device 100 may collect whether malicious actions such as stealing root privilege from the restored source code, sending private data of the user to the outside, or the like is included in the executable file. That is, the electronic device 100 may collect the suspected malicious code data by analyzing whether the executable file sends the private information of the user to the outside without permission of the user, or performs SMS transmission, a use of GPS information, transmission of picture file to the outside, and the like.

As described above with reference to FIG. 5, as an example of the present disclosure, the electronic device 100 may collect the Manifest file, the DEX file, and the native library file by decompiling the decompressed APK of Android™.

According to an exemplary embodiment of the present disclosure, the electronic device 100 may analyze the source code by analyzing the Manifest file in Android™ and then decompiling the Dex file for code analysis. In this case, even in a case in which a portion of the machine code is encrypted, the encrypted code may be decoded, and the electronic device 100 may restore the decoded code to the source code by decompiling the decoded code. The electronic device 100 may collect the suspected malicious code data of the executable file by analyzing the restored source code.

For example, the electronic device 100 may search for strings of signature of the decoded dex file and signature of the dex file stored in the memory and compare mapped addresses with each other. The electronic device 100 may confirm an optimized signature of Dex in the mapped address, and may confirm whether the dex founded in the memory through a dex header corresponds to the decoded dex. Thereby, the electronic device 100 may collect the suspected malicious code data included in the executable file by analyzing the source code restored by decompiling the encrypted machine code.

In addition, the electronic device 100 may collect the suspected malicious code data at a native source level by collecting a symbol table and a character constant through the source code of the decompiled native library file (S603).

As described above with reference to FIG. 5, when the electronic device 100 obtains the binary file by compiling the source code, the source code has the symbol table and the character constant including functions, variables, and the like used for the executable file. Therefore, the symbol table and the character constant of the executable file may be collected by decompiling the compiled binary file to again restore it to the source code. Since a detailed example is described above with reference to FIG. 5, a description thereof will be omitted.

In addition, the electronic device 100 may collect the suspected malicious code data by decompiling the executable file to an LLVM IR code using an LLVM compiler and analyzing the native source code of the executable file at an LLVM IR code level (S604). In this case, the electronic device 100 may transform the machine code of the executable file to the IR code, which is the LLVM bytes code, using the LLVM compiler.

For example, the electronic device 100 may collect the suspected malicious code data at a native or JNI level of Android™ at the IR code level. Since the LLVM IR code is described above with reference to FIGS. 3 and 5, a description thereof will be omitted.

In addition, the electronic device 100 may collect the suspected malicious code data through execution privilege information and metadata analysis for mobile operating systems (e.g., Android™, IOS™, Tizen™, and the like) of the executable file (S605).

According to an exemplary embodiment of the present disclosure, the execution privilege information for the mobile operating system is the Manifest file in the case of Android™, is the privilege_desc file in the case of Tizen™, and is Info.plist file in the case of IOS™.

For example, the Manifest file of Android™ describes privilege and components used in the executable file of the application, and an entry point of the application. Therefore, according to an exemplary embodiment of the present disclosure, in order to analyze the suspected malicious code data of the executable file, the electronic device 100 may collect the data by analyzing the entry point of Manifest.

Specifically, codes of Manifest of Android™ are as follows.

<application

android:theme= “@android:0103000F”
android:label=“@7F050000”
android:icon=“@7F020001”
android:name=“APKPMainAPP1345F”
android:debuggable=“true”
android:allowBackup=“true”
>
<activity

android:label=“@7F050000”

android:name=“com.goolge.xps.gfcfc.MainActivity”

>
<intent-filter

>
<action

android:name=“android.intent.action.MAIN”

>

</action>
<category

android:name=“android.intent.category.LAUNCHER”

>

</category>

</intent-filter>

</activity>

In this case, an attribute described between <activity></activity> is an entry point of the executable file and is a code which is firstly executed when the executable file is executed. Therefore, the electronic device 100 may collect the suspected malicious code data while sequentially analyzing classes to be called later through an analysis of MainActivity class between <activity> and </activity>.

In addition, the electronic device 100 may analyze and collect the suspected malicious code data by detecting files or commands hidden in another file format (S606).

Specifically, the APK file, which is a hidden file of Android™, may include a file having a different file format such as ELF which is different from the dex file. The decompressed APK file may include a native development kit (NDK) library file. In this case, in the NDK file, the ELF, which is an executable file format for Linux having a .so file extension is compiled for arm. In this case, according to an exemplary embodiment of the present disclosure, the electronic device 100 may collect the suspected malicious code data included in the executable file by analyzing the source code restored by decompiling the ELF file through the static analysis. In this case, the electronic device 100 may collect the suspected malicious code data through a symbol table or a character constant of the ELF. Alternatively, the electronic device 100 may collect the suspected malicious code data through the IR code or the source code restored by decompiling the ELF file.

In addition, when the executable file is represented in an extension of a specific file (e.g., an image, a video file, or the like) in Android™, the electronic device 100 may collect the suspected malicious code data by detecting a command of the executable file to determine a root privilege acquisition of the specific file. In this case, the root privilege acquisition means privilege that the specific file may enter a path on which the specific file may be executed in Android™ and access the corresponding API.

In this case, the electronic device 100 may extract a file structure of the specific file through decoding and decompression for the specific file to detect the root privilege of the specific file format. The electronic device 100 may collect the suspected malicious code data by comparing byte values of the extracted specific file and analyzing information on different extensions intended inside the specific file.

For example, in a case in which the executable file is an image file having a .png or .jpg file extension, the executable file may acquire the root privilege from the API such as an album of the user, or the like to which a picture file is able to access. However, the executable file may be a file disguised as the picture file that intentionally includes the malicious code. Therefore, the electronic device 100 may collect whether intended suspected malicious code data is present in the file format by comparing byte values of the executable file having an extension of the image file format through decoding and decompression. However, the examples described above are merely examples for describing the present disclosure, but the present disclosure may be applied to various file formats.

In addition, the electronic device 100 may analyze the suspected malicious code data through the metadata of the executable file. The metadata may include a header file and/or other data fields of the executable file. The metadata may represent various characteristics of the executable file. For example, the metadata may include various characteristics fields such as a heap size, a stack size, a header size, an image size, a code section size, an initialization data size, and the like. The electronic device 100 may collect the suspected malicious code data included in the executable file through an analysis of the characteristics fields (e.g., the heap size, the stack size, etc.) of the executable file.

In addition, the electronic device 100 may simultaneously collect the suspected malicious code data of the executable file analyzed as described above by generating a thread (S607). The electronic device 100 may store the collected suspected malicious code data in the memory and use it as the database.

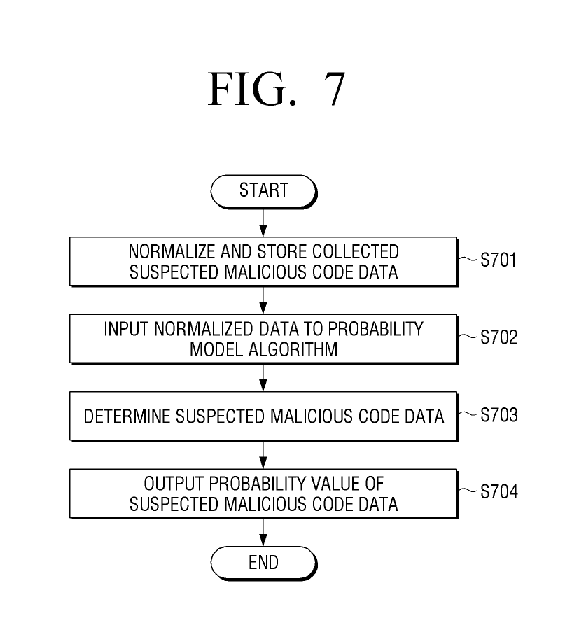

FIG. 7 is a flowchart illustrating a method for statistically measuring the collected suspected malicious code data according to an exemplary embodiment of the present disclosure.

Referring to FIG. 7, the electronic device 100 may normalize the collected suspected malicious code data through the pre-processing process and store it in the memory (S701). A general machine learning algorithm normalizes and uses the data through the pre-processing for the collected data. Since the pre-processing process is described above with reference to FIG. 5, a description thereof will be omitted.

The electronic device 100 receives the data normalized through the pre-processing process using a probability model algorithm (S702). According to an exemplary embodiment of the present disclosure, the probability model algorithm may be implemented using an artificial intelligence probability model algorithm such as a deep learning, a support vector machine (SVM), a neural network algorithm, or the like. The artificial intelligence probability model algorithm has a form in which machine learning is extended.

The electronic device 100 may determine the suspected malicious code data through the probability model algorithm (S703). As described above with reference to FIG. 5, the deep learning algorithm used in the present disclosure is an algorithm that learns the data extraction itself by including the pre-processing process in the machine learning described above in the neural network architecture Therefore, when the deep learning algorithm is used as the probability model algorithm, the pre-processing process used in the present disclosure may be omitted and it is possible to more quickly and accurately obtain the deduction result.

Specifically, as disclosed in Tables 1 and 2, a result of determining whether to include the malicious code according to the present disclosure may deduce high accuracy.

TABLE 1
Test Environment

| Operating System | Android ™ |
|---|---|
| Source of Malicious Code | Contagio Mobile ™ |
| Generation Time of Malicious Code | Since 2014 |
| Number of Malicious Codes | 137 |

TABLE 2
Comparison of Test Results of Existing Malicious Code
Detection Program and Present Disclosure

| | Classification | | | Accuracy |
|---|---|---|---|---|
| Existing Malicious Code Detection | | | | 83.94% |
| Technology (McAfee ™) | | | | |
| | Present Disclosure | False-Positive | 1% | 94.16% |
| | | Threshold | 49.7% | |
| | | False-Positive | 2% | 96.35% |
| | | Threshold | 28.5% | |

In addition, the electronic device 100 may output a probability value of the suspected malicious code data acquired through the probability model algorithm (S704). The electronic device 100 may provide a user interface (UI) including various information on the malicious code, but may also provide a simple UI by digitizing a suspected malicious code probability of executable file according to the present disclosure. Since the UI according to the present disclosure is disclosed in detail with reference to FIGS. 4 and 5, a description thereof will be omitted.

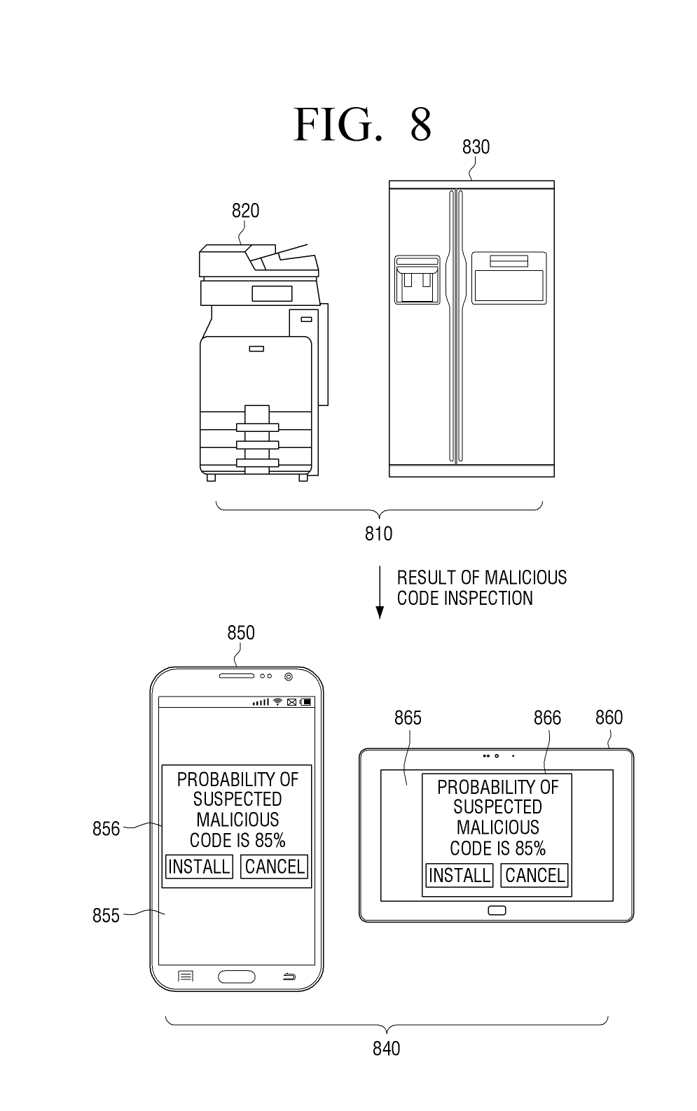

FIG. 8 is a diagram illustrating a situation in which the suspected malicious code data is detected in a first electronic device and the detected result is transmitted to a second electronic device according to an exemplary embodiment of the present disclosure.

The electronic device 100 described above may have various forms. Referring to FIG. 8, the electronic device 100 may be a printer 820, a refrigerator 830, a smartphone 850, a tablet 860, or the like. Hereinafter, a description will be provided on the assumption that the printer 820 and the refrigerator 830 are the first electronic device 810, and the smartphone 850 and the tablet 860 are the second electronic device 840. The first electronic device 810 may include, for example, electronic devices that it is difficult to carry by the user due to large volumes or large weights, and that it is difficult to move positions of the devices once the positions are determined due to characteristics of the devices. The second electronic device 840 may include, for example, electronic device that may be carried by the user due to small volumes. However, the examples described above are not limited thereto, and the electronic devices belonging to the first electronic device 810 and the second electronic device 840 may be interchangeable and may also include various electronic devices.

The first electronic device 810 and the second electronic device 840 may refer to the electronic device 100 of FIG. 1. Therefore, each of the first electronic device 810 and the second electronic device 840 may include a display, a processor (not shown), a memory (not shown), an input (not shown), and a communicator (not shown). Since the functions of the respective components of the electronic device 100 are described with reference to FIG. 1, a detailed description thereof will be omitted. In addition, the first electronic device 810 and the second electronic device 840 may detect the malicious code in the executable file and display the analysis result through the same or similar process as the electronic device 100 of FIG. 1. Since the process of detecting the malicious code and displaying the analysis result by the electronic device 100 has been described above, a detailed description thereof will be omitted.

Referring to FIG. 8, the first electronic device 810 may transmit the result of detecting the malicious code to the second electronic device 840. For example, the printer 820, which is the first electronic device 810, may download an executable file that adds an output option, check the malicious code before the executable file is installed, and transmit the check result of the malicious code to the smartphone 850, which is the second electronic device 840. The smartphone 850 or the tablet 860 may display warning messages 856 and 866 on the respective displays 855 and 865 based on the check result of the malicious code received from the printer 820.

The first electronic device 810 may transmit the analysis result of the malicious code to the second electronic device 840 in various methods. For example, the first electronic device 810 may designate the second electronic device 840 to which the analysis result of the malicious code is to be transmitted in advance. In this case, when the analysis result of the malicious code is deduced, the first electronic device 810 may transmit the analysis result of the malicious code to the second electronic device 840 using a communicator (not shown) of the first electronic device 810.

According to another exemplary embodiment of the present disclosure, the first electronic device 810 may search for the second electronic device 840 and then transmit the analysis result of the malicious code to the searched second electronic device 840. For example, the first electronic device 810 may search for a plurality of second electronic devices 840 which are in a predetermined distance from the first electronic device 810, and then transmit the analysis result of the malicious code to at least one second electronic device 840 of the searched second electronic devices 840. The first electronic device 810 may search for the second electronic device 840 using a local area network such BT, Wifi, NFC, or the like. In addition, the first electronic device 810 may transmit the analysis result of the malicious code to the searched second electronic device 840.

However, the examples described above are limited thereto, but the first electronic device 810 may search for the second electronic device 840 and transmit the analysis result of the malicious to the searched second electronic device 840 using various cellular communications (e.g., LTE, LTE-A, CDMA, WCDMA, UMTS, Wibro, GSM, or the like) and wired communications (universal serial bus (USB), high definition multimedia interface (HDMI), recommended standard 232 (RS-232), or plain old telephone service (POTS)) methods.

According to another exemplary embodiment of the present disclosure, the first electronic device 810 may transmit the analysis result of the malicious result to the second electronic device 840 which is logged in with the same identification (ID) as the first electronic device 810. For example, the first electronic device 810 and the second electronic device 840 may share the same malicious code analysis program. Each of the first electronic device 810 and the second electronic device 840 may download and install the malicious code analysis program from a server providing the malicious code analysis program, and may execute the malicious code analysis in the first electronic device 810 and/or the second electronic device 840 according to situations. In this case, the first electronic device 810 may transmit the analysis result of the malicious code to the server. The server may transmit the received analysis result of the malicious code of the first electronic device 810 to the second electronic device 840.

In addition, according to another exemplary embodiment, the first electronic device 810 and the second electronic device 840 may install different malicious code analysis programs. For example, the first electronic device 810 and the second electronic device 840 may analyze the malicious code and share the result thereof by installing different malicious code programs using a single sign on method that may execute various services or various applications with one ID.

As described above, the first electronic device 810 may share the analysis result of the malicious code with the second electronic device 840 using various methods. As a result, even in a situation in which a user carried with the second electronic device 840 is physically spaced apart from the first electronic device 810, the user may determine whether or not the malicious code included in the file intended to be installed in the first electronic device 810 is present.

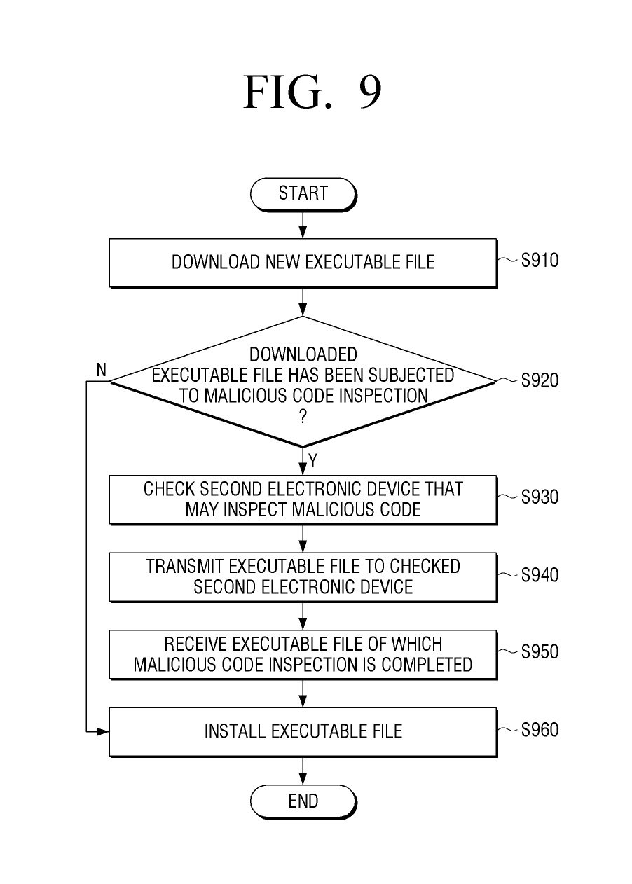

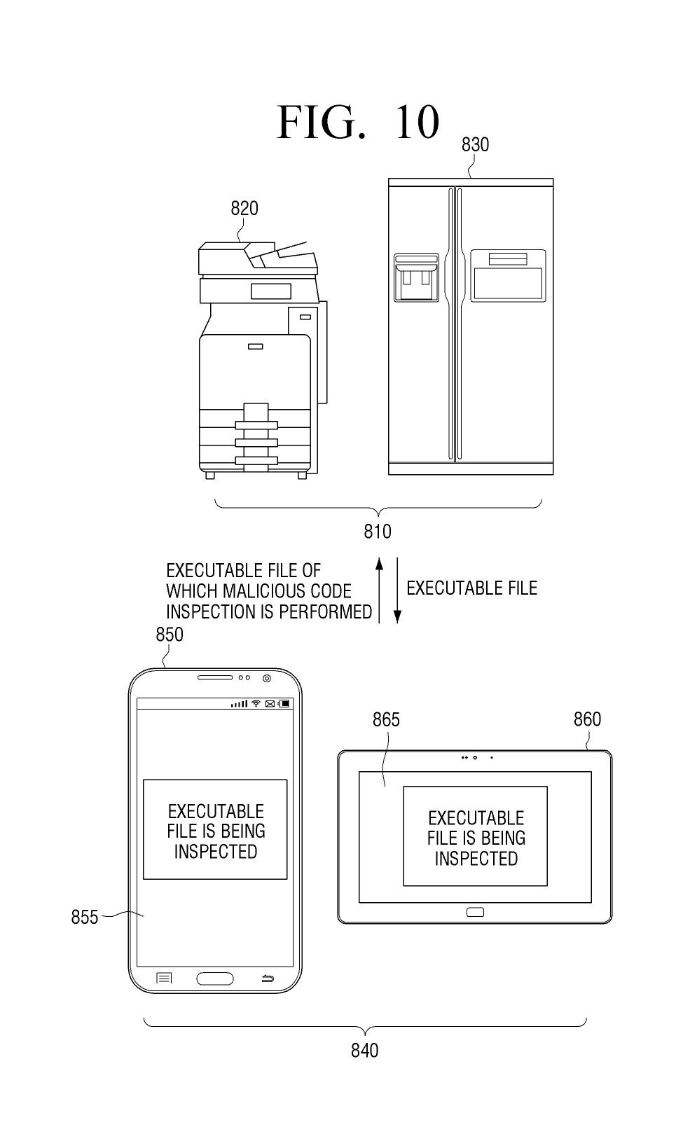

FIGS. 9 and 10 are diagrams illustrating a situation in which the suspected malicious code data is detected when a program for detecting the malicious code is not present in the electronic device according to an exemplary embodiment of the present disclosure.

Referring to FIGS. 9 and 10, the first electronic device 810 may download and install a new executable file (S910). For example, the first electronic device 810 may receive various executable files through an application store on Android™ and iOS™.

The first electronic device 810 is not installed with a program capable of the malicious code, but may check whether the received executable file has been subjected to a malicious code inspection (S920:Y). For example, the first electronic device 810 may store a record of whether or not the malicious code inspection has been performed for a predetermined region of the executable file, for the executable file that has been inspected for whether or not malicious code is present. In this case, when the first electronic device 810 receives a command to install the executable file from the user, the first electronic device 810 may check the record of whether or not the malicious code inspection has been performed for the executable file.

If the malicious code inspection is not performed (S920: N), the first electronic device 810 may check the second electronic device 840 that may inspect the malicious code using various wireless communications, wired communications, and cellular communications methods. For example, the first electronic device 810 may search for the second electronic device 840 within a designated region, may preset the designated second electronic device 840, or may check the second electronic device 840 which is logged in with the same ID as the first electronic device 810.

The first electronic device 810 may transmit the executable file to the checked second electronic device 840 (S940). The second electronic device 840 may perform the malicious code inspection for the received executable file, and may display the result on the respective displays 855 and 865 of the second electronic device 840. In this case, the second electronic device 840 may transmit the executable file of which the malicious code inspection is completed to the first electronic device 810 through a wireless communication method with the first electronic device 810, the user command, and the like. The first electronic device 810 may receive the executable file of which the malicious code inspection is completed from the second electronic device 840 (S950). The first electronic device 810 may install the executable file received from the second electronic device 840 (S960).

As described above, according to exemplary embodiments of the present disclosure, even though the first electronic device 810 is not installed with the program capable of detecting the malicious code, the first electronic device 810 may detect the malicious code before installing the executable file by using the second electronic device 840 which may be connected to the first electronic device 810 in a wired or wireless scheme.

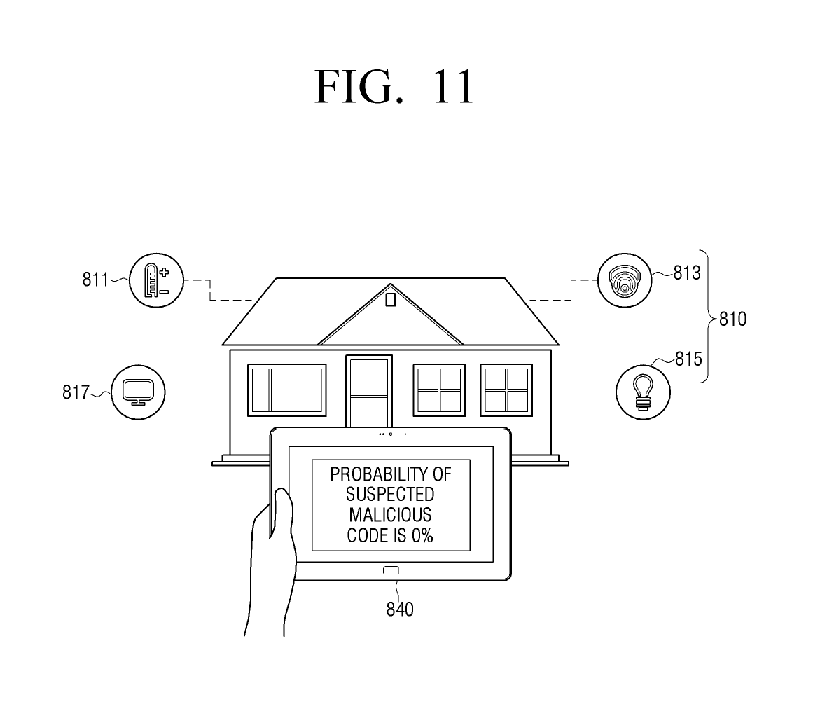

FIG. 11 is a diagram illustrating another situation in which the electronic device detects the suspected malicious code data according to an exemplary embodiment of the present disclosure.

Referring to FIG. 11, the first electronic device 810 may be a device associated with Internet Of Things disposed in a building. Internet Of Things may mean, for example, that people, things, spaces, data, and the like are connected to each other via Internet to generate, share, and utilize information.

According to an exemplary embodiment of the present disclosure, the first electronic device 810 may an Internet Of Things sensor device that collects and generates various data and then transmits the data to other electronic devices using various communication technologies. For example, the first electronic device 810 may be a sensor device that is associated with a temperature device 811, a security camera 813, a lamp 815, a TV 817, and the like to collect the information and transmit it to the outside. For example, the temperature device 811, the security camera 813, the lamp 815, the TV 817, and the like may be integrated to embed the above-mentioned sensor therein. However, the above-mentioned examples are merely examples for describing the present disclosure, and the present disclosure is not limited thereto.

The respective sensor devices 810 transmit the generated data to the device associated with each sensor or transmit it to other device, such that the data may be used for an operation of each of the devices. In addition, the respective sensor devices 810 may transmit the generated data to the second electronic device 840.

For example, if a face of a subject recognized by the security camera 813 corresponds to a person who resides in the pre-recognized building, the sensor device 810 associated with the security camera 813 may transmit data to the sensor device 810 associated with the lamp to inform that an inhabitant has approached. The sensor device 810 associated with the lamp 815 may transmit the received data to the lamp 815 to activate the lamp 815 inside the building.

The sensor devices 810 associated with Internet Of Things as described above may perform a software (SW) update, a firmware update, or the like, as needed. The sensor device 810 may download and install a file necessary to perform the SW update. The sensor device 810 may not be installed with the program capable of detecting the malicious code. In this caser, the second electronic device 840 may perform the malicious code inspection for the file to be installed in the sensor device 810 and then transmit the file of which the inspection is completed to the sensor device 810. The sensor device 810 may perform the SW update using the received file.

In addition, according to various exemplary embodiments, in a case in which the program for detecting the malicious code is installed in the sensor device 810, the sensor device 810 may perform the malicious code inspection by receiving the file necessary to perform the SW update. In this case, the sensor device 810 may transmit the inspection result to the second electronic device 840.

As described above in FIGS. 1 to 11, a malicious code recognition rate of the executable file according to the present disclosure may acquire a high malicious code recognition rate through malicious code analysis data (characteristics data) which is input to the deep learning engine. To this end, the electronic device 100 may store data collected for the malicious code analysis in a specific memory position inside the electronic device 100 that runs the executable file. Specifically, the collected information, which is data for analyzing the native source, may be, for example, header file information, a function name, and the like. That is, the collected information may be the suspected malicious code data collected through the symbol table and the character constant of the executable file, and the suspected malicious code data analyzed by decompiling the executable file into the IR code level using the LLVM compiler.

The electronic device 100 may acquire the root privilege about the operating system for the data for analyzing the native source described above and may store the collected suspected malicious code data in a RAM or a hard disk.

In a case in which the collected suspected malicious code data is stored in the RAM, the electronic device 100 may store the data in a specific position or the entire memory through a process of generating a memory dump. For example, Android™ may perform a quick dump using a direct memory access (DMA) scheme. In addition, hardware methods that are limited by a version of the operating system (OS) using JTAG or are less likely to be affected by a root kit may also be used. Other mobile operating systems may also store and check the data in the same manner as the method described above.

On the other hand, in a case in which the collected suspected malicious code data is stored in the hard disk, the electronic device 100 may store the data in a specific position when it operates at an application level. For example, Android™ may store the collected data in an internal memory (/data/data/packagename/databases/), and may also it in an external memory (/mnt/sdcard/packagename/). Therefore, the electronic device 100 may store the data in the external memory and the specific position of the external memory, and may check a position of the data. IOS™ may store the suspected malicious code file in a current folder and a documents folder to check the position of the data for analysis.

As another example, in the case of the cloud based, the electronic device 100 may update the collected data in the database of the server to perform a dynamic analysis. In this case, the electronic device 100 may read the data for analysis sent to the server to check the data for analysis.

By the methods and the electronic device 100 according to the present disclosure described above, even if the electronic device 100 does not update the database associated with the malicious code by connecting with Internet, the electronic device 100 may analyze the suspected malicious code data through a recognition engine (e.g., the deep learning, SVM, neural network, and the like) in a local of a user device. In addition, the recognition engine is configured in an artificial intelligence form capable of self-learning, which does not require an additional update of the database.

In addition, from the entire scenario viewpoint, the present disclosure may have an effect that an inspection time may be reduced as compared to the conventional malicious code detection technology including a process of updating the database and transmitting the executable file to the server. When the methods according to the present disclosure are used, there is an advantage that as a malicious code analysis and detection time running on the user device, the inspection time of about 1 second is used.

The methods according to the present disclosure may be recorded on a computer readable medium and executed by a computer to execute the functions described above.

As such, in order to execute the method according to each exemplary embodiment of the present disclosure, the methods described above may include codes which are coded in a computer language such as C, C++, Java, machine language, and the like which may be read by a processor (CPU) of the computer.

The above-mentioned code may further include a memory reference related code as to what additional information or media necessary to execute the methods described above by the computer (the processor) should be referenced at any position (address) of an internal or external memory of the computer.

In addition, when the processor of the computer needs to communicate with any other computer or server at a remote location to perform the functions described above, the code may further include a communication related code as to how the processor of the computer should communicate with any other computer or server at a remote position using a communication module (e.g., a wired and/or wireless communication module) of the computer, or which information or media should be transmitted or received at the time of communication.

The device (e.g., the modules or the electronic device 100) or the method (e.g., the operations) according to the diverse exemplary embodiments of the present disclosure may be performed, for example, by at least one computer (e.g., the processor 120) executing instructions included in at least one program of programs maintained in a computer-readable storage media.

If the instructions are executed by the computer (e.g., the processor 120), at least one computer may perform functions corresponding to the instructions. In this case, the computer-readable storage media may be, for example, the memory 130.

The program may be included in the computer-readable storage media such as, for example, a hard disk, a floppy disk, a magnetic media (e.g., a magnetic tape), an optical media (e.g., a compact disc read only memory (CD-ROM), a digital versatile disc (DVD), a magneto-optical media (e.g., a floptical disk)), a hardware device (e.g., a read only memory (ROM), a random access memory (RAM), or a flash memory), and the like. In this case, the storage media is generally included as a portion of the configuration of the electronic device 100, but may also be mounted through a port of the electronic device 100, or may also be included in an external device (e.g., a cloud, a server or another electronic device) positioned external to the electronic device 100. In addition, the program may also be divided to be stored in a plurality of storage media, and in this case, at least some of the plurality of storage media may also be positioned in the external device of the electronic device 100.

The instructions may include a high-level language code capable of being executed by a computer using an interpreter, or the like, as well as a machine language code made by a compiler. The above-mentioned hardware device may be constituted to be operated as one or more software modules to perform the operations of the diverse exemplary embodiments.

Hereinabove, although the exemplary embodiments of the present disclosure have been shown and described, it should be understood that the present disclosure is not limited to the disclosed embodiments and may be variously changed without departing from the spirit and the scope of the present disclosure. Therefore, the present disclosure should be construed as including all the changes, equivalents, and substitutions included in the spirit and scope of the present disclosure.

1. A method for analyzing a malicious code of an electronic device, the method comprising:
receiving an executable file;
collecting suspected malicious code data from the executable file by analyzing the executable file before installing the received executable file;
determining the suspected malicious code data by analyzing the collected suspected malicious code data based on a probability model algorithm; and
outputting a result of the determination.

2. The method as claimed in claim 1, wherein the collecting of the suspected malicious code data includes restoring a machine code of the executable file into a source code level by decompiling the machine code, and
the suspected malicious code data is collected at the restored source code level.

3. The method as claimed in claim 2, wherein in the restoring of the machine code, when the machine code of the executable file is encrypted, the machine code is restored into the source code level by decompiling the machine code.

4. The method as claimed in claim 1, wherein the collecting of the suspected malicious code data includes analyzing the suspected malicious code data at a native source level by collecting a symbol table and a character constant of the executable file.

5. The method as claimed in claim 1, wherein the collecting of the suspected malicious code data includes analyzing the suspected malicious code data at a native source level by decompiling the executable file into an intermediate representation (IR) code level using a low level virtual machine (LLVM) compiler.

6. The method as claimed in claim 1, wherein the collecting of the suspected malicious code data includes analyzing the suspected malicious code data based on metadata of the executable file and execution privilege information of the executable file within a mobile operating system.

7. The method as claimed in claim 1, wherein the collecting of the suspected malicious code data includes analyzing the suspected malicious code data based on different information data inside the file through decoding, decompression, a check of a header file, and a comparison of byte values for each particular file so as to detect another executable file or a command hidden in another file format in the executable file.

8. The method as claimed in claim 1, further comprising normalizing the collected data so as to allow the normalized data to be input to the probability model algorithm.

9. The method as claimed in claim 1, wherein in the outputting of the result of the determination, when it is determined that the malicious code data is present as the result of the determination, at least one of type and probability information of the determination malicious code data is output.

10. The method as claimed in claim 1, wherein the probability model algorithm is at least one of a deep learning engine, a support vector machine (SVM), and a neural network algorithm.

11. An electronic device for analyzing a malicious code, the electronic device comprising:
a display; and
a processor configured to receive an executable file, collect suspected malicious code data from the executable file by analyzing the executable file before installing the received executable file, determine the suspected malicious code data by analyzing the collected suspected malicious code data based on a probability model algorithm, and output a result of the determination.

12. The electronic device as claimed in claim 11, wherein the processor restores a machine code of the executable file into a source code level by decompiling the machine code, and collects the suspected malicious code data at the restored source code level.

13. The electronic device as claimed in claim 12, wherein when the machine code of the executable file is encrypted, the processor restores the machine code into the source code level by decompiling the machine code.

14. The electronic device as claimed in claim 11, wherein the processor collects the suspected malicious code data by analyzing the suspected malicious code data at a native source level by collecting a symbol table and a character constant of the executable file.

15. A computer readable recording medium having a program for performing a method for analyzing a malicious code of an electronic device stored thereon, wherein the method includes:
receiving an executable file;
collecting suspected malicious code data from the executable file by analyzing the executable file before installing the received executable file;
determining the suspected malicious code data by analyzing the collected suspected malicious code data based on a probability model algorithm; and
outputting a result of the determination.
